(19) United States
(12) Patent Application Publication
(10) Pub. No.: US 2007/0132309 A1
(43) Pub. Date: Jun. 14, 2007

(54) Hydraulic vehicle brake

(76) Inventors: Volker Knop, Ulmen (DE); Thomas Winkler, Mainz (DE); Jurgen Balz, Hunstetten-Oberlibbach (DE); Jurgen Volkel, Frankfurt/M. (DE); Lothar Schiel, Hofheim (DE); Thomas Peichl, Wollstadt (DE)

Correspondence Address: CONTINENTAL TEVES, INC., ONE CONTINENTAL DRIVE, AUBURN HILLLS, MI, 48326-1581, US

(21) Appl. No.: 10/588,829

(22) PCT Filed: Feb. 9, 2005
(86) PCT No.: PCT/EP05/50574

§ 371 Date: Aug. 9, 2006

(30) Foreign Application Priority Data
Feb. 9, 2004 (DE) 10 2004 006 436.9
Oct. 11, 2004 (DE) 10 2004 049 656.0
Dec. 27, 2004 (DE) 10 2004 062 810.6

(51) Int. Cl. B60T 13/74

(52) U.S. Cl. 303/3

(57) ABSTRACT

A hydraulic vehicle brake includes a brake housing in which a hydraulic working pressure chamber is delimited by a brake piston, wherein the brake piston, in the applied condition, can be locked by means of a locking device, locking thereof being allowed by a relative movement of a force-transmitting element, wherein an energy accumulator cooperating with the brake piston is provided, which is comprised of a lockable accumulator pressure chamber, an accumulator piston delimiting the accumulator pressure chamber, and at least one spring element being supported on the accumulator piston. To perform a parking brake operation, the locking device is activated in that the force-transmitting element after a hydraulic pressure buildup is arrested by an electromagnetic or electromechanical actuator so that a relative movement between the accumulator pressure chamber and the force-transmitting element is rendered possible.

### BACKGROUND OF THE INVENTION

The present invention relates to a hydraulic vehicle brake, in particular for motor vehicles, including a brake housing in which a hydraulic working pressure chamber is delimited by a brake piston, wherein the brake piston, in the applied condition, can be locked by means of a locking device, locking thereof being allowed by a relative movement of a force-transmitting element, wherein an energy accumulator cooperating with the brake piston is provided, which is comprised of a lockable accumulator pressure chamber, an accumulator piston delimiting the accumulator pressure chamber, and at least one spring element being supported on the accumulator piston.

WO 2004/027282 A1 discloses a hydraulic vehicle brake of this type being described in particular by way of FIGS. 3a and 3b. In the prior art hydraulic brake, it is arranged that the parking brake device is operable by a hydraulic pressure introduced into the working pressure chamber and that the energy accumulator can be charged by the hydraulic pressure. In the embodiment described by way of FIGS. 3a and 3b, there is an accumulator pressure chamber operable with the aid of a valve, which thus includes an operable hydraulically pre-loadable spring element. The spindle of the locking device designed as a threaded-nut/spindle combination is locked in this embodiment in order to perform a parking brake operation, with the result that the brake piston is locked. A stepping mechanism is provided to this end, which cooperates with the accumulator piston and permits relative movements of different length towards the brake piston. In the event of leakage of the valve that operates the accumulator pressure chamber, inadvertent locking of the brake piston during a service brake operation is possible. This causes unwanted blocking of the assigned wheel, what is considered disadvantageous.

In view of the above, an object of the invention is to improve a hydraulic vehicle brake with a parking brake device of the type mentioned hereinabove to such effect that a possible leakage of the valve operating the accumulator pressure chamber does not cause an unwanted activation of the parking brake function, thus augmenting traffic safety.

### SUMMARY OF THE INVENTION

According to the invention, this object is achieved in that the force-transmitting element can be entrained by the accumulator piston in a direction opposite to the direction of application of the brake piston and can be arrested by an electromagnetic or an electromechanical actuator so that a relative movement is rendered possible between the force-transmitting element and the accumulator piston.

In a favorable embodiment of the invention, a stepped bore accommodating the force-transmitting element is provided in the accumulator piston.

A favorable improvement of the subject matter of the invention provides that the force-transmitting element has an axial collar which is supported at the transition of the different diameters of the stepped bore.

In a particularly favorable embodiment of the invention, the locking device is a threaded-nut/spindle assembly, the threaded nut thereof being supported on the brake piston or being integrally designed with the brake piston, while the spindle includes a first friction surface cooperating, in the locked condition, with a second friction surface that is arranged in a non-rotatable manner at the accumulator piston.

In this arrangement, the force-transmitting element forms a central bearing for the spindle.

In a favorable improvement of the subject matter of the invention, there is provision of another spring element that moves the collar of the force-transmitting element into abutment at the transition of the different diameters of the stepped bore.

In another advantageous embodiment of the invention, the electromagnetic actuator cooperates with an armature plate being in a force-transmitting connection with the force-transmitting element.

The coil of the electromagnetic actuator performs the function of a sensor for detecting the position of the armature plate.

In an alternative embodiment, the electromechanical actuator performs the function of a sensor for detecting the position of the force-transmitting element. In this embodiment, the force-transmitting element is connected to the accumulator piston by way of a preferably self-locking thread. Besides, the electromechanical actuator exercises a relative movement between the accumulator piston and the force-transmitting element, which is independent of its position, using a preferably self-locking thread and an adaptive connection.

It is arranged that the hydraulic accumulator pressure chamber can be closed by means of an electrically operable valve.

Another especially favorable design variant of the subject matter of the invention provides that the pressure buildup is executed both in the working pressure chamber and in the hydraulic pressure chamber or accumulator pressure chamber, respectively, by means of a hydraulic pump which is used as an independent-pressure source of an electrohydraulic brake system, for example.

Alternatively, pressure is built up both in the working pressure chamber and in the accumulator pressure chamber by means of a pressure generator that can be actuated by the driver.

The invention will be described in detail hereinbelow by way of two embodiments, making reference to the accompanying drawings.

### BRIEF DESCRIPTION OF THE DRAWINGS

In the drawings:

FIG. 1 is an axial cross-sectional view of a first design of the hydraulic vehicle brake of the invention in the released condition;

FIG. 2 is an axial cross-sectional view of a second design of the hydraulic brake of the invention.

### DETAILED DESCRIPTION OF THE DRAWINGS

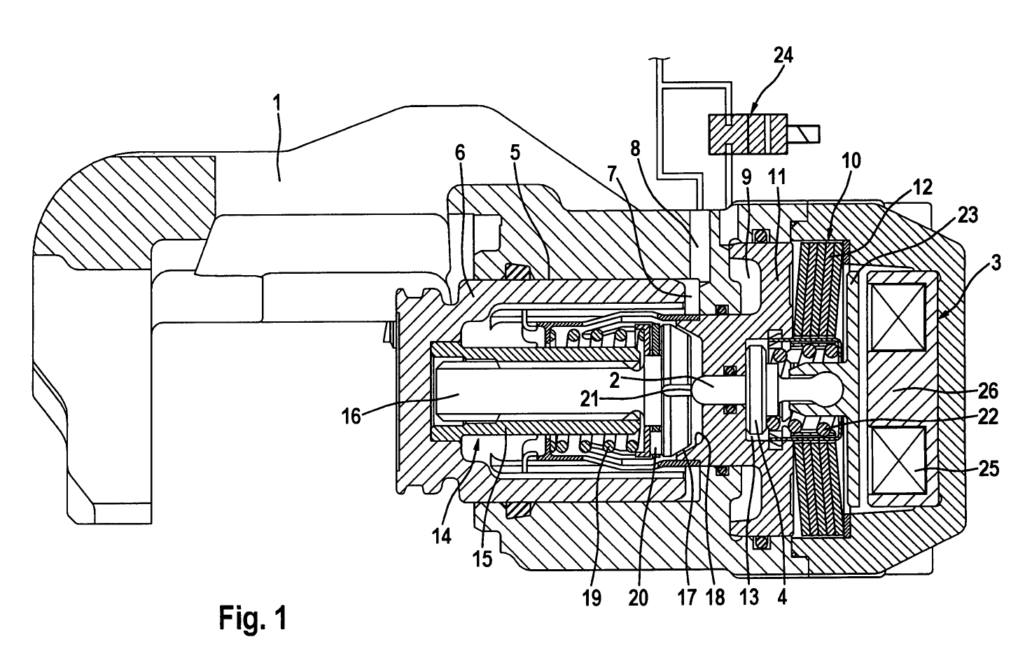

The first design of the hydraulic vehicle brake of the invention shown in FIG. 1 includes a brake housing 1 straddling the outside edge of a brake disc (not shown) and two brake pads (likewise not shown). The brake housing 1 forms on its inside surface a brake cylinder 5 receiving a brake piston 6 in an axially displaceable manner. By way of a hydraulic port 8, brake fluid can be fed into the working pressure chamber 7 formed between brake cylinder 5 and brake piston 6, whereby brake pressure develops that displaces the brake piston 6 axially towards the brake disc. This will urge the brake pad facing the brake piston 6 against the brake disc, whereupon the brake housing 1, as a reaction, displaces in the opposite direction and thereby urges also the other brake pad against the brake disc.

As can be taken from FIG. 1 in addition, an energy accumulator 10 is arranged at the side of the brake housing 1 remote from the brake piston 6. Energy accumulator 10 is mainly comprised of a hydraulic accumulator pressure chamber 9, an accumulator piston 11 delimiting the accumulator pressure chamber 9, as well as a spring element 12 being designed as an assembly of cup springs and supported at the accumulator piston 11 in the example shown. The energy stored in the energy accumulator 10 acts on the brake piston 6 during a parking brake operation, as will be explained in more detail in the following. It is hereby achieved that the application force that acts on the brake pads is almost independent of thermally induced changes in length in the area of the brake housing 1.

A spindle drive or a threaded-nut/spindle assembly 14, respectively, forms a locking device, which is necessary for realizing a parking brake function in the design illustrated in FIG. 1. The mentioned threaded-nut/spindle assembly 14 comprises a threaded nut 15 and a spindle 16 being in connection with each other by means of a non-self-locking thread. In this arrangement, the threaded nut 15 is rigidly connected to the brake piston 6, while the spindle 16 at its end remote from the brake piston 6 includes a preferably conical first friction surface 17, which can be moved into and out of engagement with a second friction surface 18 that is arranged in the accumulator piston 11 in a non-rotatable fashion. For this purpose, a force-transmitting element 2 is provided, which is received in a cylindrical stepped bore 13 in the accumulator piston 11, projects through the latter and forms a central bearing 21 for thee spindle 16. After a relative movement of the force-transmitting element 2 in relation to the accumulator piston 11, the function of the central bearing 21 is omitted, and the two friction surfaces 17, 18 are in engagement with each other, as will be explained in more detail hereinbelow. Further, a spring 19 supported on the brake housing 1 biases the spindle 16 in the direction of the second friction surface 18 or the central bearing 21, respectively, by the intermediary of an axial bearing 20.

The first design of the hydraulic vehicle brake of the invention is illustrated in FIG. 1 in the released condition of the parking brake. To lock the parking brake, a pressure generator, not referred to in detail, is used to build up hydraulic pressure initially both in the working pressure chamber 7 and in the accumulator pressure chamber 9. To this end, an electrically operable valve, which is preferably configured as a normally closed (NC) valve 24 must adopt its open operating position. The brake piston 6 displaces to the left in the drawing as a reaction to the pressure buildup in the working pressure chamber 7, while the accumulator piston 11 is displaced to the right in the drawing in opposition to the action of force of the preloaded spring element 12. The spring element 12 is compressed in this action. As this occurs, the accumulator piston 11 entrains the force-transmitting element 2 in that a collar 4 designed at the force-transmitting element 2 is supported at the transition between small and large diameter of the stepped bore 13. The accumulator piston 11 and, hence, the force-transmitting element 2 are displaced to the right due to the above-mentioned pressure buildup in the accumulator pressure chamber 9 until an armature plate 23, which is in a force-transmitting connection with the force-transmitting element 2, moves into abutment with an electromagnetic actuator 3. In this action, the spindle 6 continues bearing against the central bearing 21 due to the action of force of the spring 19, with the result that the two friction surfaces 17, 18 cannot become engaged.

Subsequently, the electromagnetic actuator 3 is energized, with the result that the armature plate 23 is arrested by the electromagnetic actuator 3 in its stop position described above. In a following pressure reduction in the working pressure chamber 7 and in the accumulator pressure chamber 9, the brake piston 6 moves to the right in the drawing, while the accumulator piston 11 moves to the left. Arresting of the force-transmitting element 2 enables a relative movement between the force-transmitting element 2 and the accumulator piston 11, whereby the function of the central bearing 21 for the spindle 16 is cancelled and the two friction surfaces 17, 18 are moved into engagement with each other. The biased spring element 12 mentioned hereinabove presses the accumulator piston 11, the spindle 16 blocked due to the friction surfaces 17, 18 being in engagement, the threaded nut 15, and thus the brake piston 6 to the left in the drawing and against the brake disc (not shown), respectively. The vehicle brake is thereby locked in its applied condition. Thereafter the electromagnetic actuator 3 is no more energized, and the armature plate 23 and the force-transmitting element 2, respectively, are no more arrested. The valve 24 adopts its de-energized state, and is hence closed. Thus, the hydraulic vehicle brake does not require energy and hydraulic pressure in order to maintain the locking engagement in the applied condition, which is considered as an advantage.

To release the locking engagement, in turn, hydraulic pressure is built up in the working pressure chamber 7 and, after a corresponding actuation of the NC valve 24, likewise in the accumulator pressure chamber 9. The hydraulic pressure, in turn, would displace the brake piston 6 in FIG. 1 to the left and the accumulator piston 11 to the right. However, it is sufficient for unlocking the parking brake when the accumulator piston 11 is relieved from load. Another spring element 22, which moves the force-transmitting element 2 into abutment at the transition between small and large diameter of the stepped bore 13, urges the force-transmitting element 2 in the direction of the spindle 16 and pushes the engaged friction surfaces 17, 18 open, when the accumulator piston 11 is relieved from load in a corresponding manner. Thereafter, the force-transmitting element 2 forms a central bearing 21 for the spindle 16 again.

As can be seen in FIG. 1, the above-mentioned further spring element 22 takes care that in the event of a service brake operation, where only the working pressure chamber 7 is acted upon by pressure, the force-transmitting element 2 is not displaced because it is biased by the further spring element 22 in opposition to the action of force of the hydraulic pressure in the working pressure chamber 7. The accumulator piston 11 is neither displaced in a service brake operation because the effective diameter of the accumulator piston 11 close to the working pressure chamber 7 is smaller than the effective diameter of the brake piston 6. Also, the spring element 12 designed with a preloading force defined by construction acts in opposition to the pressurization in the working pressure chamber 7, what likewise prevents displacement of the accumulator piston 11 during a service brake operation.

The coil 25 of the electromagnetic actuator 3 fulfils the function of a sensor for sensing the position of the armature plate 23, which position allows detecting whether locking of the vehicle brake is or is not possible. In addition, especially the action of the armature plate 23 striking against the electromagnetic actuator 3 is a signal for the pressure generator (not referred to in detail) to terminate the pressure buildup for performing a parking brake operation in the pressure chambers 7, 9. To reliably determine the position of the armature plate, the change of inductance of the coil 25 of the electromagnetic actuator 3, being caused by the movements of the armature plate, is defined. This is done in that voltage pulses are applied to the coil 25. The variation of the current that flows through the coil 25 is simultaneously determined. This current variation indicates the position of the armature plate 23 and, thus, the position of the force-transmitting element 2. As the position of the armature plate 23 changes, the variation of the current that flows through the coil 25 will change as well. The change of inductance of the coil 25 mainly depends on the size of the slot between the armature plate 23 and the iron yoke 26 of the electromagnetic actuator 3.

It is of course also feasible to employ a sensor element for sensing the armature plate position or for determining the position of the force-transmitting element 2, respectively. This sensor element can be designed as a Hall sensor or as a magneto-resistive sensor element, both allowing non-contact sensing.

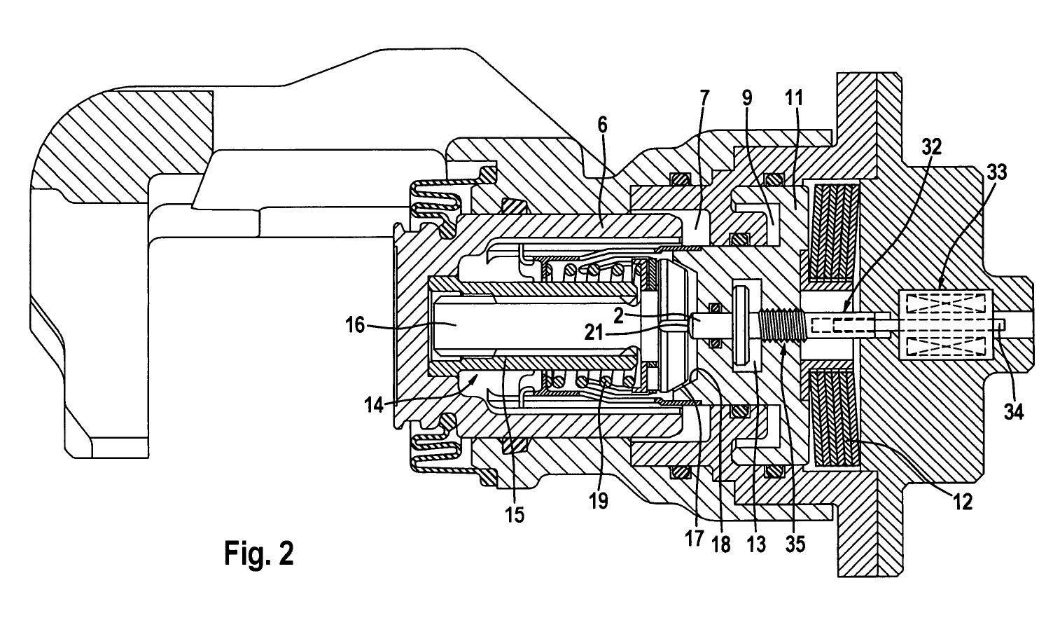

The second embodiment of the vehicle brake of the invention, as illustrated in FIG. 2, differs from the embodiment described with respect to FIG. 1 mainly by the use of an electromechanical actuator 33 instead of the electromagnetic actuator 3 for arresting the force-transmitting element 2.

As can be seen in FIG. 2, the electromechanical actuator 33 drives a driving shaft 34, which is connected to the rotor (not shown) of the electromechanical actuator 33. The driving shaft 34, in turn, is connected to, and drives, the force-transmitting element 2. However, the connection between the driving shaft 34 and the force-transmitting element 2 is configured as an adaptive connection 32 so that a relative movement between the above-mentioned components is possible.

The force-transmitting element 2 is connected to the accumulator piston 11 by way of a self-locking thread 35 and provides the function of a central bearing 21 for the spindle 16, as in the first embodiment described hereinabove. When the force-transmitting element 2 is turned by the electromechanical actuator 33 to the right in the drawing, the first friction surface 17 that is designed at the spindle 16 and the second friction surface 18 that is designed in a non-rotatable manner on the accumulator piston are moved into engagement with each other. Locking in the embodiment shown in FIG. 2 likewise occurs after pressure buildup in the working pressure chamber 7 and in the accumulator pressure chamber 9. According thereto, the brake piston 6 is displaced to the left in the drawing in the direction of the brake disc not shown, on the one hand, and the accumulator piston 11 is displaced to the right in the drawing. Due to the connection between the accumulator piston 11 and the force-transmitting element 2 in the form of the self-locking thread 35 that has just be described, the force-transmitting element 2 is entrained by the accumulator piston 11 and displaced to the right in the drawing. In this action, the driving shaft 34 and the force-transmitting element 2 perform a relative movement at the connection 32 of the two components described hereinabove. Besides, the spindle 16 continues bearing against the force-transmitting element 2 in this operation due to the action of force of the spring 19 described above, while the friction surfaces 17, 18 are not in engagement with each other. The two friction surfaces 17, 18 do not move into engagement with each other until the electromechanical actuator 33 is actuated correspondingly and the force-transmitting element 2 is moved to the right in the drawing induced by the rotation of the driving shaft 34. Subsequently, the spindle 16 is blocked and the pressure introduced into the pressure chambers 7, 9 reduced. The spring assembly 12 described above will now act through the accumulator piston 11, the engaged friction surfaces 17, 18, and the threaded-nut spindle assembly 14 on the brake piston 6 which is thus locked in the state of application.

To release the locking engagement, in turn, hydraulic pressure is built up in both pressure chambers 7, 9 until the accumulator piston 11 is relieved from load and the electromechanical actuator 33 is strong enough to have the two engaged friction surfaces 17, 18 pushed open by the force-transmitting element 2.

In the embodiment illustrated in FIG. 2, the electromechanical actuator 33 further exercises the function of a sensor for sensing the position of the force-transmitting element 2. With this information, it must be found out whether the vehicle brake is locked or released. To this end, the current requirement of the electromechanical actuator 33 is determined, and the position of the driving shaft 34 and, hence, the position of the force-transmitting element 2 can be deduced therefrom. Alternatively, a so-called step counter sensor can be employed, which determines the number of rotations of the electromechanical actuator 2. In turn, the position of the force-transmitting element 2 can be found out with the aid of this information.

The separate accumulator pressure chamber 9 is omitted in another embodiment (not shown). A brake piston and an accumulator piston are actuated in this embodiment by a pressure introduced into a joint pressure chamber. The spring element 12 described with regard to FIGS. 1 and 2 prevents movement of the accumulator piston during service brake operations. To perform a parking brake operation, the force-transmitting element is actuated accordingly by an electromechanical actuator so that two friction surfaces can move into engagement with each other, which are designed at the accumulator piston and at the threaded spindle of a threaded-nut/spindle assembly that cooperates with the brake piston. To release the parking brake, the electromechanical actuator actuates the force-transmitting element, with the result that the just mentioned friction surfaces are disengaged.

It is particularly favorable in the embodiments according to FIG. 1 and FIG. 2 of the invention that locking engagement is not possible due to a defect of the NC valve 24. This is because a relative movement between the force-transmitting element 2 and the accumulator piston 11 is required for locking purposes, which movement can only be realized when the electromagnetic actuator 3 or the electromechanical actuator 33 arrest or actuate the force-transmitting element 2, respectively.

Various pressure generation aggregates, being preferably actuatable by independent force, are used for pressure buildup both in the working pressure chamber 7 and in the accumulator pressure chamber 22, 9. Thus, it is possible to use a hydraulic pump, for example, which serves as an independent-pressure source of an electrohydraulic brake system. The use of an actuating unit with an independently actuatable brake booster and a master brake cylinder connected downstream of the brake booster is also feasible. Alternatively, however, a pressure generating means operable by the driver may be used as well.

1.-14. (canceled)

15. A hydraulic vehicle brake, including a brake housing (1) in which a hydraulic working pressure chamber (7) is delimited by a brake piston (6), wherein the brake piston (6), in the applied condition, can be locked by means of a locking device, locking thereof being allowed by a relative movement of a force-transmitting element (2), wherein an energy accumulator (10) cooperating with the brake piston (6) is provided, which is comprised of a lockable accumulator pressure chamber (9), an accumulator piston (11) delimiting the accumulator pressure chamber (9), and at least one spring element (12) being supported on the accumulator piston (11), wherein the force-transmitting element (2) can be entrained by the accumulator piston (11) in a direction opposite to the direction of application of the brake piston (6) and can be arrested by an electromagnetic or an electromechanical actuator (3, 33) so that a relative movement between the force-transmitting element (2) and the accumulator piston (11) is rendered possible.

16. The hydraulic vehicle brake as claimed in claim 15,
wherein a stepped bore (13) accommodating the force-transmitting element (2) is provided in the accumulator piston (11).

17. The hydraulic vehicle brake as claimed in claim 16,
wherein the force-transmitting element (2) has an axial collar (4) which is supported at the transition of the different diameters of the stepped bore (13).

18. The hydraulic vehicle brake as claimed in claim 17,
wherein there is provision of another spring element (22) that moves the collar (4) of the force-transmitting element (2) into abutment at the transition of the different diameters of the stepped bore (13).

19. The hydraulic vehicle brake as claimed in claim 15,
wherein the locking device is a threaded-nut/spindle assembly (14), the threaded nut (15) thereof being rigidly connected to the brake piston (6) or being integrally designed with the brake piston (6), while the spindle (16) includes a first friction surface (17) cooperating, in the locked condition, with a second friction surface (18) that is arranged in a non-rotatable manner at the accumulator piston (11).

20. The hydraulic vehicle brake as claimed in claim 19,
wherein the force-transmitting element (2) forms a central bearing (21) for the spindle (16).

21. The hydraulic vehicle brake as claimed in claim 15,
wherein the actuator (3) is electromagnetically operated and cooperates with an armature plate (23) being in a force-transmitting connection with the force-transmitting element (2).

22. The hydraulic vehicle brake as claimed in claim 21,
wherein the coil (25) of the electromagnetic actuator (3) performs the function of a sensor for detecting the position of the armature plate (23).

23. The hydraulic vehicle brake as claimed in claim 15,
wherein the actuator (33) is electromechanically operated and performs the function of a sensor for detecting the position of the force-transmitting element (2).

24. The hydraulic vehicle brake as claimed in claim 23,
wherein the force-transmitting element (2) is connected to the accumulator piston (11) by way of a locked thread (35).

25. The hydraulic vehicle brake as claimed in claim 23,
wherein the electromechanical actuator (33) exercises a relative movement, which is independent of its position, between the accumulator piston (11) and the force-transmitting element (2) by way of a self-locking thread (35) and an adaptive connection (32).

26. The hydraulic vehicle brake as claimed in claim 15,
wherein the hydraulic accumulator pressure chamber (9) can be closed by means of an electrically operable valve (24).

27. The hydraulic vehicle brake as claimed in claim 15,
wherein a pressure buildup is executed both in the working pressure chamber (7) and in the accumulator pressure chamber (9) by means of a hydraulic pump.

28. The hydraulic vehicle brake as claimed in claim 15,
wherein a pressure is built up both in the working pressure chamber (7) and in the accumulator pressure chamber (9) by means of a pressure generator that can be manually actuated.
